(19) United States
(12) Patent Application Publication
(10) Pub. No.: US 2025/0384378 A1
(43) Pub. Date: Dec. 18, 2025

(54) Life Cycle Impact Estimation

(71) Applicant: The Carbon Platform, San Francisco, CA (US)

(72) Inventors: John Newman, San Francisco, CA (US); Dye-Zone Chen, Palo Alto, CA (US); William Bradley, Arlington, MA (US); Karl Knaub, Waunakee, WI (US)

(73) Assignee: The Carbon Platform, San Francisco, CA (US)

(21) Appl. No.: 19/233,868

(22) Filed: Jun. 10, 2025

Related U.S. Application Data
(60) Provisional application No. 63/658,891, filed on Jun. 12, 2024.

(51) Int. Cl. G06Q 10/0637

(52) U.S. Cl. CPC G06Q 10/06375

(57) ABSTRACT

An apparatus and a method for calculating the environmental impact of a product from sparse input data are described. The system receives input data, such as a textual description or an image, that lacks a complete bill of materials. A generative artificial intelligence model automatically deconstructs the product into a plurality of constituent components and associated lifecycle activities. An environmental impact is determined for each component, and the contributions are aggregated to estimate the total impact for the product. The system may further store and compare calculated impacts with previous estimates in a database to return the value associated with the lowest error.

### CROSS-REFERENCE TO RELATED APPLICATIONS

This is a conversion of, and claims priority to, U.S. Provisional Patent Application 63/658,891, “Life Cycle Impact Estimation”, filed on Jun. 12, 2024 by John Newman, Dye-Zone Chen, William Bradley, and Karl Knaub, said provisional patent application incorporated herein by reference in its entirety.

### BACKGROUND

This application is related to the field of climate change mitigation, and specifically to the calculation of life cycle impacts, for instance, carbon footprints, water usage, land impact, biogenics, etc.

By carbon, we mean the set of gases that contribute to global warming, commonly referred to as Greenhouse Gases (GHGs), including but not limited to carbon dioxide, methane, nitrous oxide, and fluorinated gases. When a carbon footprint is reported, it may be in units such as kilograms of carbon dioxide equivalent (CO2e), where one unit of CO2e is the amount of heat an equal amount of CO2 would be expected to trap over the next 100 years. In a separate embodiment, by carbon footprint, we also anticipate the calculation of a product carbon footprint that accounts for direct land-use change, land management emissions and removals, other biogenic emissions associated with raw material production, precursor production, packaging, product manufacturing and transport, the biogenic carbon content in the product, biogenic carbon dioxide withdrawals, and indirect land-use change.

In a further embodiment, the approach outlined herein calculates additional environmental impacts of products, including, but not limited to ozone depletion (for example, reported in kilograms equivalent to unit emissions of CFC-11), acidification of soil and water (for example reported in kilograms equivalent to unit emissions of SO2), water eutrophication (for example, reported in kilograms equivalent to unit emissions of (PO4)3−), photochemical ozone formation (for example, reported in kilograms equivalent to unit emissions of C2H4), the depletion of abiotic resources—elements (for example reported in kilograms equivalent to unit emissions of Sb), the depletion of abiotic resources—fossil fuels (reported for example as mega Joules), and water and air pollution (both reported, for example, in units of cubic meters). Other quantities that may be estimated include: the use of renewable primary energy, excluding renewable primary energy resources used as raw materials; the use of renewable primary energy resources used as raw materials; total use of renewable primary energy resources (primary energy and primary energy resources used as raw materials); use of non-renewable primary energy, excluding non-renewable primary energy resources used as raw materials' use of non-renewable primary energy resources used as raw materials; total use of non-renewable primary energy resources (primary energy and primary energy resources used as raw materials); use of secondary materials; use of renewable secondary fuels; use of non-renewable secondary fuels; net use of fresh water; hazardous waste disposed of; non-hazardous waste disposed of; radioactive waste disposed of; components for re-use; materials for recycling; materials for energy recovery; exported energy; total use of primary energy during the life cycle.

Addressing the existential threat of climate change requires multifaceted strategies due to uncertainties regarding which methods will be effective within the narrowing window of opportunity for action. Recognizing that “what gets measured gets done,” the inventions develop a fully automated system to quantify the carbon footprint of products. This system aims to empower any person, company, or entity to establish a baseline carbon footprint, to understand the potential impact of various mitigation options, and to start taking action and making tradeoffs to decarbonize.

The inventions may be used by both consumers and enterprises. For consumers, particularly the 45% of consumers who expect sustainability as a basic prerequisite for every brand or product or are experiencing “eco-anxiety,” there is a deep need for accessible and reliable carbon footprint data to inform purchasing decisions. Today, it is extremely difficult to find reliable carbon footprint information and essentially impossible to compare products. This paucity of information, stretching back decades, is due to the strict reliance of Life Cycle Assessment (LCA) analyses on complete Bills of Materials (BOMs), making LCA impractical for the vast majority of products where such data is unavailable. For enterprises, especially those committed to net-zero goals (i.e., balancing the amount of greenhouse gases produced and removed from the atmosphere through their operations) or subject to various regulatory reporting requirements, one difficulty is in gaining visibility into the carbon footprint of their supply chains. In particular, as upstream suppliers get increasingly smaller, eventually they lack the resources or time to provide detailed emissions data.

For consumers, the innovation may offer a “carbon footprint facts label,” enabling informed purchasing decisions akin to nutrition labels. This transparency can drive consumer preference towards products with lower carbon footprints, rewarding companies that minimize environmental impacts and encouraging a virtuous cycle of market-wide sustainability. For enterprises, the system may provide data on Scope 1, 2, and 3 emissions, where Scope 1 (Direct Emissions) refers to emissions from sources owned or controlled by a company, Scope 2 (Indirect, Purchased Energy) refers to emissions from the generation of purchased electricity, heating, or cooling used by the company, and Scope 3 (Indirect, Value Chain Emissions) refers to all other indirect emissions from the company's value chain, divided into upstream emissions (those from suppliers and inputs, such as raw material extraction, manufacturing of purchased goods, and transportation to the company) and downstream emissions (those from customers and outputs, such as product use, end-of-life disposal, and downstream logistics). There is particular demand for Scope 3 upstream data to map supplier emissions and facilitate more effective decarbonization strategies (suppliers hesitate to share emissions information lest it be used as leverage against them in future cost negotiations). While many companies providing Product Carbon Footprints (PCFs) require ingestion of supplier Bill Of Materials (BOMs) for their calculations, the current technical innovations do not necessarily require a BOM. Rather, one can calculate PCFs starting from text descriptions, images, and/or catalog photos (and also complete BOMs, datasheets, process flows, etc.).

The system represents a transformative advance in estimating PCFs by completely automating this process, leveraging artificial intelligence and machine learning to handle data at scale, rapidly and accurately. The approach can work with sparse input data, including text descriptions and images, and enhance and fill in missing information at various levels of granularity through generative artificial intelligence such as Large Language Model (LLM) or Large Reasoning Model (LRM) techniques. The system may collect and organize both structured and unstructured data at scale, using both curated datasets and automated web searches. This is followed by pattern-matching product identification, packaging identification (if applicable), automated material decomposition, manufacturing breakdown, and logistics mode enumeration.

### BRIEF SUMMARY

The present application discloses systems and methods that overcome the long-standing limitations of conventional Life Cycle Assessment (LCA) by providing a system that can accurately estimate environmental impacts from sparse, unstructured data, as opposed to complete, error-free Bills of Materials (BOMs). The requirement for complete, error-free BOMs makes LCA impractical for the vast majority of products where such data is unavailable, proprietary, or prohibitively expensive to obtain. Numerous attempts in the art to automate LCA have focused on structured data ingestion (often preceded by time-consuming and costly Information Technology (IT) transformation projects designed to structure, clean, digitalize, and centrally store product data), and have failed to address the fundamental problem of data sparsity. Consequently, a significant and long-felt need exists for a method to rapidly and accurately estimate a carbon footprint from limited, unstructured inputs like a simple text description or a photograph. In one aspect, the current invention achieves this through a unique multi-stage generative AI architecture that deconstructs a product and validates the results against physical and manufacturing constraints, achieving a level of accuracy previously thought unattainable without a complete Bill of Materials.

In one aspect, an apparatus for calculating a carbon footprint of a product includes one or more processing units. The apparatus also includes memory electrically connected to the one or more processing units. The apparatus also includes a computer screen or an application programming interface (API), connected to the one or more processing units. The apparatus also includes where the one or more processing units receive, from the computer screen or the API, identifying information of the product, disambiguate the identifying information to derive a unique product identifier, recursively search for components of the product, determine the carbon footprint of each component, if instructed, substitute a known carbon footprint for each component, sum the carbon footprint of each component, add the carbon footprint to an additional product carbon footprint component of manufacturing of each component, add the carbon footprint to shipping and transportation for each component, model an error estimate for the carbon footprint, store the carbon footprint and the error estimate for each component in a database, search the database for a previously calculated carbon footprint and a previous error estimate of each component, and return the carbon footprint and the error estimate for the previously calculated carbon footprint or the carbon footprint, depending on which error estimate is lower. The apparatus also includes displaying the carbon footprint and the error estimate on the computer screen or through the API.

The input device may be a network interface connected to a network. The output device may be a network interface connected to a network. The input device may be a keyboard. The one or more processing units may be communicatively coupled to at least one input interface. The input interface may be configured to receive information identifying one or more products for which a carbon footprint is to be calculated. In various embodiments, the input interface may be implemented in a variety of ways to receive this information from numerous types of data sources. For example, the input interface may comprise a graphical user interface (GUI), presented on a computer screen, which is configured to accept manual data entry from a user. In other embodiments, the input interface may comprise an Application Programming Interface (API), configured to receive the product information programmatically from an external software system. In yet other embodiments, the input interface may comprise a file processing module configured to read and parse the product information from a data file, such as a comma-separated values (CSV) file, an XML file, a JSON file, or a text file provided via a command-line argument. In further embodiments, the input interface may comprise a database connection module configured to retrieve the product information by querying one or more records in a database. The scope of the invention is not limited to these examples, and other known or future-developed means for receiving data into a computing system are also contemplated.

The apparatus may also include where the computer screen is connected to the one or more processing units over a network. The apparatus may also include where the additional product carbon footprint component is overhead. The overhead may include capital goods, fuel and energy, yield loss, recycling, and operational waste. The apparatus may also include where the shipping and transportation includes business travel and employee commute. The apparatus may also include where the carbon footprint of each component is determined using a Generative Artificial Intelligence model or a Large Vision Model. The steps to calculate the carbon footprint may self-optimize. The self-optimization may optimize prompts to the large language model. The self-optimization may change the predictive model used. The apparatus may also include where the one or more processing units format the carbon footprint and the error estimate to support 3rd party validation. The apparatus may also include where the one or more processing units format the carbon footprint and the error estimate to support 3rd party audits. The identifying information could be a photograph, a brief text description, a CAD drawing, a sketch, a line drawing, or similar.

In one aspect, a method for calculating a carbon footprint of a product includes receiving, from a computer screen or an API, information identifying of the product. The method also includes the disambiguation, by one or more processing units, the information to derive a unique product identifier. The method also includes recursively searching for components of the product, determining the carbon footprint of each component, if instructed, substituting a known carbon footprint for each component, summing the carbon footprint of each component, adding the carbon footprint of an overhead of manufacturing of each component, adding the carbon footprint of shipping and transportation for each component, modeling an error estimate for the carbon footprint, storing the carbon footprint and the error estimate for each component in a database, searching the database for a previously calculated carbon footprint and a previous error estimate of each component, and returning the carbon footprint and the error estimate for the previously calculated carbon footprint or the carbon footprint, depending on which error estimate is lower. The method also includes displaying the carbon footprint and the error estimate on the computer screen or sending the data through the API. One could programmatically examine a list of 10,000 products and only display the 5 products with the largest carbon footprints.

The input device may be a network interface connected to a network. The output device may be a network interface connected to a network. The output device may be a computer screen. The method may also include where the computer screen is connected to the one or more processing units over a network. The method may also include where the shipping and transportation includes company vehicles and distribution. The method may also include where the carbon footprint of each component is determined using a generative artificial intelligence model. The method may also include where the carbon footprint of each component is determined using a large language model. The method may further include formatting the carbon footprint and the error estimate to support 3rd party validation. The method may further include formatting the carbon footprint and the error estimate to support 3rd party audits. The method may further include self-optimizing the calculation of the carbon footprint. The self-optimizing may optimize prompts to the predictive model after inputs to the predictive model. The self-optimizing may change the generative artificial intelligence model used. The self-optimizing may change the large language model used. The identifying information could be a photograph, a brief text description, a CAD drawing, a sketch, a line drawing, or similar.

In one aspect, a method for calculating a carbon footprint of a portfolio of products includes receiving, from a computer screen, information identifying of the portfolio of products. The method also includes for each product in the portfolio of products, disambiguate, by one or more processing units, the information identifying of the portfolio of products for each product to derive a unique product identifier. The method also includes for each product in the portfolio of products recursively executing steps of searching for components of each product, determining the carbon footprint of each component, if instructed, substituting a known carbon footprint for each component, summing the carbon footprint of each component, adding the carbon footprint of an overhead of manufacturing of each component, adding the carbon footprint of shipping and transportation for each component, modeling an error estimate for the carbon footprint, storing the carbon footprint and the error estimate for each component in a database, searching the database for a previously calculated carbon footprint and a previous error estimate of each component, and returning the carbon footprint and the error estimate for the previously calculated carbon footprint or the carbon footprint, depending on which error estimate is lower; summing the carbon footprint for each product into an aggregate carbon footprint. The method also includes for each product in the portfolio of products displaying the aggregate carbon footprint on the computer screen.

In one aspect, a computer-implemented method for estimating the environmental impact of a product is described. The method includes the steps of receiving, by one or more processing units, input data identifying the product. The input data may include at least one of a textual description, a numerical description, or an image of the product. The input data may lack a complete pre-defined bill of materials for the product. The method includes the steps of automatically deconstructing, by one or more processing units, using a generative artificial intelligence model, the product into a plurality of constituent components. The deconstruction includes inferring material compositions, manufacturing processes, packaging materials, and transportation steps associated with the constituent components based at least in part on the input data and information retrieved from one or more databases. The method further includes the steps of determining, by one or more processing units, an environmental impact contribution for each of the plurality of constituent components. The determination for at least one component involves accessing a database of emissions factors. The method also includes the steps of aggregating, by one or more processing units, the environmental impact contributions of the plurality of constituent components to generate an estimate of the environmental impact of the product.

While the conventional wisdom in the LCA field “teaches away” from using sparse data due to perceived unreliability, the present inventions' use of a specific generative artificial intelligence model enables the deconstruction of a product into a plurality of constituent components without a pre-defined BOM. One of the technical challenges is developing a structured prompt hierarchy that constrains the model's output to conform to ISO 14067 standards. Without this prompt structure, the model's output may be inconsistent and unsuitable for standardized LCA calculations.

The deconstruction may be achieved by a multi-stage GenAI pipeline where an LVM first identifies primary components from an image, and a specialized LLM, fine-tuned on a proprietary dataset of engineering schematics, is then prompted with a structured query to infer material compositions and manufacturing process steps for each identified component. This specific architecture overcomes the technical problem of data sparsity that prevents conventional LCA systems from functioning.

The generative artificial intelligence model may comprise at least one of a large language model (LLM), or a large reasoning model (LRM), or a large vision model (LVM). The automatic deconstruction of the product may further comprise inferring logistics modes associated with the constituent components. The method may further comprise the step of determining, by the one or more processing units using the generative artificial intelligence model, whether further deconstruction of a specific constituent component is warranted based on a predefined criterion related to an expected change in the estimate of the environmental impact of the product or adherence to an industry standard boundary condition. The input data may be further processed by an entity disambiguation microservice to derive a unique product identifier prior to the deconstruction step.

A computer-implemented method for improving the accuracy of a generative artificial intelligence (GenAI) model in predicting product lifecycle characteristics for environmental impact assessment is also described here. The method comprises providing, by one or more processing units, a training dataset. The training dataset includes, for each of a plurality of reference products, input data comprising at least one of a textual description or an image, and corresponding known ground-truth lifecycle characteristics. The method further comprises, for a selected reference product from the training dataset, the steps of generating, by the one or more processing units using the GenAI model based on its current configuration and the input data for the selected reference product, a predicted set of lifecycle characteristics. The predicted set of lifecycle characteristics includes at least one of material composition, manufacturing process, or logistics information. The steps further include calculating, by one or more processing units, a prediction error by comparing the predicted set of lifecycle characteristics with the corresponding known ground-truth lifecycle characteristics for the selected reference product. The steps also include adjusting, by one or more processing units, (i) one or more parameters of the GenAI model, and/or (ii) a prompt structure used to query the GenAI model, based on the calculated prediction error, to improve future prediction accuracy for product lifecycle characteristics.

The training dataset may include annotated product photographs. As real-world examples, the conditions under which input images are acquired may distort products' appearances relative to how a human would perceive them: best-in-class LVMs routinely assess metallic products to be ceramic or plastic; LVMs also incorrectly interpret the dimensions of products contained within images showing both a product and a measurement scale (e.g., a metric rule) due to their inability to anticipate and adjust for parallax error. Such errors may be compensated via the fine-tuning of an LVM component of the Gen AI model. The adjustments may include fine-tuning an LVM component of the GenAI model based on errors in identifying components from the annotated photographs. The adjustment may include modifying the prompt structure used by the prompt formulation microservice (518) to optimize the prediction of key lifecycle drivers that have a disproportionately large impact on the calculated environmental footprint. The method may further comprise analyzing, by one or more processing units, a distribution of prediction errors across multiple reference products; and generating, based on said analysis, an indicator identifying a type of additional training data most likely to improve overall prediction accuracy of the GenAI model. The prediction error may be calculated using a median absolute percent error (MAPE) metric.

In one aspect, a system for dynamically self-optimizing the estimation of the environmental impact of a product is described. The system comprises one or more processing units and a memory. The memory stores non-transitory, machine-readable instructions that, when executed by the one or more processing units, tell the system to perform an initial estimation of an environmental impact for a reference product using a first operational configuration, the first operational configuration including at least one of a specific generative artificial intelligence (GenAI) model from a plurality of available GenAI models, a specific prompt structure for querying the GenAI model, or a specific data retrieval strategy. The instructions further instruct the processing units to store an initial performance metric associated with the initial estimation, the initial performance metric reflecting at least one of accuracy, speed, completion rate, input requirements, compact instruction following, or computational cost of the initial estimation. The instructions further instruct the processing units to subsequently identify a second operational configuration, different from the first operational configuration, where the second operational configuration includes at least one of a specific generative artificial intelligence (GenAI) model from a plurality of available GenAI models, a specific prompt structure for querying the GenAI model, or a specific data retrieval strategy. The instructions further instruct the processing units to perform a subsequent estimation of the environmental impact for the reference product using the second operational configuration. The instructions further instruct the processing units to determine a subsequent performance metric associated with the subsequent estimation, and automatically select one of the first or second operational configurations for future environmental impact estimations of products based on a comparison of the initial performance metric and the subsequent performance metric against one or more predefined optimization objectives. The self-optimization may consider results for more than one reference product. In one embodiment, the system implements a multi-armed bandit algorithm to perform the selection. Each ‘arm’ corresponds to a unique operational configuration (e.g., “GPT-4 with prompt A”, “Gemini with prompt B”). The system performs estimations using different arms, and based on the resulting performance metrics (a weighted score of accuracy, latency, and cost), it updates the probability of selecting each arm for future tasks, thereby converging on the optimal configuration over time.

The plurality of available GenAI models may include models with different architectures or from different providers, and wherein identifying the second operational configuration comprises selecting a different GenAI model from the plurality. The predefined optimization objectives may include a weighted consideration of estimation accuracy, processing speed, and monetary cost associated with utilizing the GenAI model. The instructions may further configure the system to trigger the identification of the second operational configuration in response to at least one of the availability of a new GenAI model, a predefined time interval, or the input received from a human-in-the-loop review process. Performing the initial estimation and the subsequent estimation may involve utilizing one or more microservices of a Footprint Orchestrator (552), including at least a prompt formulation microservice (518) and a life cycle assessment containerized microservice (524).

A system for high-throughput estimation of environmental impacts for a plurality of products is described here. The system may include one or more processing units configured for parallel processing, and a memory storing non-transitory, machine-readable instructions. The non-transitory, machine-readable instructions, when executed by one or more processing units, are configured to receive input data identifying a batch of M products, where M is an integer greater than 100 (in some cases, M is greater than 1,000). For each of the M products, the instructions concurrently initiate an environmental impact estimation process. Each environmental impact estimation process includes instructions to automatically deconstruct, using a generative artificial intelligence (GenAI) model, the product into a plurality of constituent components and associated lifecycle activities based on sparse input data about the product. The environmental impact estimation process also includes instructions to determine an environmental impact contribution for each of the plurality of constituent components and associated lifecycle activities. The environmental impact estimation process also includes instructions to aggregate the environmental impact contributions to generate an estimate of the environmental impact for the product. The instructions are also configured to manage the concurrent estimation processes, including monitoring completion status of computational sub-tasks within each process and re-initiating failed sub-tasks. The instructions are also configured to complete the estimation of environmental impacts for at least a predefined significant portion of the M products within a predetermined time T, wherein T is substantially less than M multiplied by a nominal time for a single sequential estimation. As used herein, “substantially less” means a reduction in total processing time of at least one order of magnitude. For example, T is less than (M*N)/10, where N is the nominal time for a single estimation.

The instructions may further configure the system, prior to initiating deconstruction for a product or component, to query a database (e.g., retrieval proxies 546, vector database 544) for a previously calculated environmental impact or pre-computed component characteristics, and to utilize said previously calculated impact or pre-computed characteristics if available and applicable, thereby avoiding redundant GenAI model invocations. The instructions may further configure the system to, for a product with a previously stored environmental impact estimate and associated key lifecycle drivers, receive an update to an emissions factor for one of said key lifecycle drivers, and rapidly recalculate the product's environmental impact by modifying only the contribution of the updated key lifecycle driver without re-executing the full deconstruction process using the GenAI model. The GenAI model invocations for deconstructing different products or components may be distributed across a plurality of GenAI model instances operating in parallel. M may be greater than 100,000 and T is less than one hour.

In one aspect, a computer-implemented method for estimating an environmental impact of a product from sparse input data is described. The method includes receiving, by one or more processing units, sparse input data purporting to identify a product, wherein the sparse input data comprises a limited textual description or one or more images of the product and lacks a detailed specification of the product's components and manufacturing. The method also includes processing, by the one or more processing units using an entity disambiguation module communicatively coupled to a generative artificial intelligence (GenAI) model or Large Visual Model, the sparse input data to determine at least one of a unique product identifier corresponding to a known product entity in a database, or a bounded set of plausible product entities represented by the sparse input data, each plausible product entity associated with a confidence score. In response to determining the unique product identifier or at least one plausible product entity exceeding a predefined confidence threshold, the method includes retrieving or generating, by the one or more processing units using the GenAI model, a detailed lifecycle model for the identified unique product or for each of the at least one plausible product entity. The lifecycle model includes inferred constituent components, material compositions, and manufacturing processes. The method further includes calculating, by the one or more processing units based on the detailed lifecycle model(s), an estimated environmental impact for the unique product or for each of the at least one plausible product entity. The method further includes outputting, by the one or more processing units, the estimated environmental impact(s).

Suppose a bounded set of plausible product entities is determined. In that case, the output may further comprise, for each estimated environmental impact, an indication of key assumptions made by the GenAI model in generating the corresponding lifecycle model. The processing of the sparse input data may further comprise determining whether the information content of the sparse input data is insufficient to identify a unique product or a bounded set of plausible product entities with adequate confidence. In response to such a determination, the system may output a request for additional clarifying information. The limited textual description may comprise fewer than ten words, and the GenAI model may infer a plurality of specific descriptive elements, including at least an estimated mass, a primary material composition, one or more likely manufacturing processes, and a probable logistics mode and origin, from said limited textual description. The entity disambiguation module may be the entity disambiguation microservice (514), and the GenAI model may be invoked via the prompt formulation microservice (518) and LLM Proxies (540) or LVM Proxies (542).

A computer-implemented method for comprehensive product impact assessment is described here. The method includes receiving, by one or more processing units, input data identifying a product and a selection of a plurality of distinct impact categories, wherein the plurality of distinct impact categories includes carbon footprint and at least one additional environmental or resource impact category selected from the group consisting of water usage, land impact, biogenics, ozone depletion, acidification, water eutrophication, photochemical ozone formation, and depletion of abiotic resources. The method further includes automatically deconstructing, by one or more processing units using a generative artificial intelligence (GenAI) model, the product into a plurality of constituent components and associated lifecycle activities based on the input data. For each of the selected plurality of distinct impact categories, the method comprises determining, by one or more processing units, an impact contribution for each of the plurality of constituent components and associated lifecycle activities, wherein said determination involves accessing one or more databases containing impact factors specific to that impact category. The method further comprises aggregating, by one or more processing units, the impact contributions for that impact category to generate an estimate of the product's impact for said category. The method further includes outputting, by one or more processing units, the estimates for each of the selected plurality of distinct impact categories.

The input data may comprise at least one of a textual description or an image of the product and lack a complete, pre-defined bill of materials. The method may further include prioritizing, by one or more processing units, the selected plurality of distinct impact categories based on at least one of industry relevance, regulatory requirements, or user-defined criteria, and presenting the outputted estimates according to said prioritization. For at least one impact category, the GenAI model may be further used to qualitatively assess a potential societal or reputational consequence associated with the product's estimated impact in that category by correlating the impact with information from external data sources comprising at least one of news articles, regulatory filings, or public opinion data. The lifecycle activities may include at least raw material extraction, manufacturing, transportation, product usage, and end-of-life disposal.

In one aspect, a computer-implemented method for predictive value chain analytics is described. The method comprises generating, by one or more processing units using a generative artificial intelligence (GenAI) model, a baseline lifecycle model for a product, the baseline lifecycle model comprising a plurality of lifecycle parameters, including at least material compositions, manufacturing processes, and logistics data inferred from input data identifying the product. The method also comprises calculating, by one or more processing units based on the baseline lifecycle model, a baseline environmental impact and a baseline cost associated with the product. The method also comprises receiving, by one or more processing units, a definition of a scenario, the scenario comprising at least one proposed modification to one or more of the lifecycle parameters in the baseline lifecycle model. The method further comprises generating, by one or more processing units using the GenAI model, a modified lifecycle model for the product reflecting at least one proposed modification. Generating the modified lifecycle model includes the GenAI model inferring one or more consequential changes to other lifecycle parameters or associated supply chain factors resulting from the proposed modification. The method also comprises calculating, by one or more processing units based on the modified lifecycle model, a modified environmental impact and a modified cost associated with the product under the scenario. The method further comprises outputting, by one or more processing units, a comparative analysis of the baseline and modified environmental impacts and costs.

The proposed modification may include a substitution of a first material with a second, lower-carbon alternative material. The inferred consequential changes may include the GenAI model predicting potential changes in material availability, supplier lead times, or component manufacturing compatibility associated with the second material. The scenario may be defined by a core objective, such as a target decarbonization level. The GenAI model may be further configured to propose a plurality of alternative modifications to lifecycle parameters to achieve said core objective, each proposal including an estimated cost, feasibility, and lead time. The output of the comparative analysis may include presenting a financial business case, including at least one of a net present value (NPV) calculation for implementing the scenario, a cost driver tree, or a grading of the product's environmental impact under the scenario relative to an industry average. The method may further comprise analyzing lifecycle models for a portfolio of products to determine an aggregated demand for a specific lower-carbon material resulting from applying the scenario across the portfolio, thereby informing a directed-sourcing strategy.

A computer-implemented method for cross-entity environmental impact analysis is described herein. The method includes the steps of accessing, by one or more processing units, product identification data for a plurality of products associated with a plurality of distinct entities, wherein the distinct entities comprise at least one of different companies or different industries. The steps include, for each product in the plurality of products, generating, using a generative artificial intelligence (GenAI) model, an estimated environmental impact based on input data for the product. The estimation for all products adheres to a standardized methodology and a common set of boundary conditions. The steps of the “for each” loop further include aggregating, by one or more processing units, the estimated environmental impacts for products associated with each distinct entity to determine an entity-level aggregated environmental impact. The steps of the “for each” loop further include generating, by one or more processing units, a comparative analysis output, the output presenting a comparison of the entity-level aggregated environmental impacts across at least a subset of the plurality of distinct entities.

The method may further include, for products associated with a specific company entity, recursively decomposing the company's product portfolio into individual products and estimating the contribution of each product's environmental impact to an overall environmental impact for the company's portfolio. The method may further include incorporating external data, including at least one of company revenue data, industry classification codes, or country-level import/export statistics, to contextualize or normalize the estimated environmental impacts for the comparative analysis. The comparative analysis output may identify, for a specific industry, a distribution of environmental impacts among companies within that industry, thereby enabling benchmarking. The generation of the estimated environmental impact for each product may utilize a high-throughput system capable of processing estimations for more than 1,000 products concurrently.

A computer-implemented method for continuous monitoring of a product's environmental impact is described here. The method comprises generating, by one or more processing units, an initial lifecycle model of a product using a generative artificial intelligence (GenAI) model, the initial lifecycle model identifying a plurality of key lifecycle parameters and their contributions to an initial estimated environmental impact of the product. The method also comprises storing, by one or more processing units, the initial lifecycle model and the initial estimated environmental impact. The method also comprises subsequently detecting, by one or more processing units, a trigger event indicating a change in an external data source relevant to at least one of the key lifecycle parameters of the stored initial lifecycle model. In response to detecting the trigger event, the method includes automatically retrieving updated data from the external data source corresponding to the changed key lifecycle parameter, generating, by one or more processing units, an updated lifecycle model by incorporating the updated data into the initial lifecycle model, wherein said incorporation primarily adjusts the contribution of the changed key lifecycle parameter without requiring a full de novo deconstruction of the product by the GenAI model, and calculating, by the one or more processing units based on the updated lifecycle model, an updated estimated environmental impact for the product. The method further comprises outputting, by one or more processing units, the updated estimated environmental impact, thereby enabling near real-time monitoring.

The key lifecycle parameters may include at least one of an emissions factor for a specific material, a carbon intensity of an energy source used in manufacturing, or a transportation distance or mode. The detection of the trigger event may include receiving a notification from an Application Programming Interface (API) communicatively coupled to the external data source, the external data source providing time-variable data such as real-time grid carbon intensity or fluctuating commodity prices affecting material impacts. The method may further comprise translating the change between the initial estimated environmental impact and the updated estimated environmental impact into at least one of a monetary cost implication, progress towards a predefined decarbonization target, or an input for a “what-if” scenario analysis. The generation of the updated lifecycle model and calculating the updated estimated environmental impact may be completed in substantially less than one minute from the detection of the trigger event, enabled by the rapid calculation capabilities of the system.

In one aspect, a computer-implemented method for automatically generating decarbonization recommendations for a product is described. The method comprises generating, by one or more processing units using a first generative artificial intelligence (GenAI) model, a lifecycle model of the product, the lifecycle model identifying a plurality of components, associated materials, manufacturing processes, and their respective contributions to a baseline carbon footprint of the product. The method also comprises identifying, by one or more processing units based on the lifecycle model, one or more key drivers of the baseline carbon footprint. The method also comprises, for at least one identified key driver, automatically generating, by one or more processing units using a second GenAI model or the first GenAI model with a specific recommendation-generation prompt, a plurality of potential decarbonization actions. Each decarbonization action specifies a modification to the product's lifecycle model. For each of the plurality of potential decarbonization actions, the method includes estimating, by the one or more processing units, a potential reduction in carbon footprint and an associated implementation cost, and outputting, by one or more processing units, a ranked list of the potential decarbonization actions based at least in part on their estimated potential reduction in carbon footprint and associated implementation cost.

The automatic generation of the plurality of potential decarbonization actions may include the GenAI model proposing alternative materials with lower carbon intensity for a component identified as a key driver. The automatic generation of the plurality of potential decarbonization actions may include the GenAI model proposing an alternative product that serves a similar functional outcome as the original product but has a lower inherent carbon footprint. The ranked list may present decarbonization actions ordered by a metric of cost per unit of carbon footprint reduction. Each potential decarbonization action in the output list may be further associated with an estimated feasibility score and an estimated implementation timeline, both generated by the GenAI model.

A computer-implemented method for identifying financial opportunities or risks associated with product lifecycle characteristics is described herein. The method comprises generating, by one or more processing units for each of a plurality of products within a defined market segment or portfolio, a lifecycle model using a generative artificial intelligence (GenAI) model, each lifecycle model comprising data on at least constituent materials, manufacturing energy requirements, and transportation logistics. The method further comprises aggregating, by one or more processing units, data from the lifecycle models across the plurality of products to determine a current aggregated demand for specific input resources, including at least one of specific materials or specific energy types. The method also comprises simulating, by one or more processing units, a future state scenario involving a widespread adoption of a predefined decarbonization action across the plurality of products. The predefined decarbonization action includes at least one of a material substitution or a manufacturing process change aimed at reducing environmental impact. The method further comprises predicting, by one or more processing units based on the simulated future state scenario, a future aggregated demand for the specific input resources, and identifying a predicted shift in demand between the current aggregated demand and the future aggregated demand for said resources. The method further comprises correlating, by one or more processing units, the predicted shift in demand with financial data associated with the specific input resources to generate an output indicating at least one potential financial opportunity or financial risk.

The financial data may include at least one of current market prices, projected future prices, or supply elasticity for the specific input resources. The output may indicate a potential financial opportunity that includes identifying a specific low-carbon input material with a predicted significant increase in demand, thereby suggesting an opportunity for securing long-term sourcing contracts or investments in production capacity for the material. The output may indicate a potential financial risk that includes identifying a company heavily reliant on an input resource with a predicted significant decrease in demand or a significant increase in carbon-related costs, thereby informing a merger and acquisition (M&A) due diligence process or an investment-divestment strategy. The method may further comprise continuously recalculating the predicted shift in demand and the correlated financial opportunity or risk in response to updated financial data or revised decarbonization trend information.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 is a diagram of the classic product value chain.

FIG. 2A is a diagram of the input functions of the calculation of the Product Carbon Footprint.

FIG. 2B is a diagram of the calculation of the Product Carbon Footprint.

FIG. 2C is a diagram of the output functions of the calculation of the Product Carbon Footprint.

FIG. 3A is a functional chart of the calculation methodology for the Product Carbon Footprint. FIGS. 3B, 3C, 3D, and 3E show the details of FIG. 3A.

FIG. 3B is a detailed view of the front-end section of the calculation methodology for the Product Carbon Footprint.

FIG. 3C is a detailed view of one section of the footprint orchestrator of the calculation methodology for the Product Carbon Footprint.

FIG. 3D is a detailed view of another section of the footprint orchestrator of the calculation methodology for the Product Carbon Footprint.

FIG. 3E is a detailed view of the services section of the calculation methodology for the Product Carbon Footprint.

FIG. 4 is a diagram of the underlying calculation logic.

FIG. 5 is an example output of the Product Carbon Footprint calculation.

FIG. 6 is a block diagram of a possible hardware implementation.

### DETAILED DESCRIPTION

All illustrations of the drawings are for the purpose of describing selected versions of the present inventions and are not intended to limit the scope of the present inventions.

While the discussion below uses the example of a product carbon footprint, this method and apparatus could be used for water usage, land impact, biogenics, etc. as well as carbon footprints.

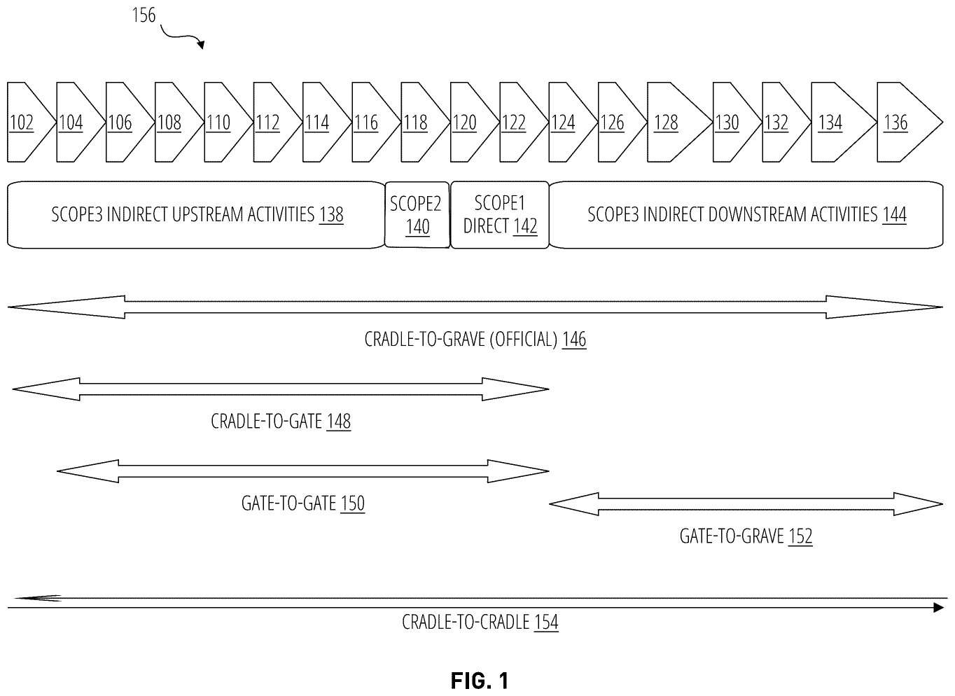

FIG. 1 shows the classic product value chain 156, starting with raw materials and progressing to the end-of-life. Included are purchased goods and services, fuel, energy, shipping, transportation, waste, etc., from cradle to grave. FIG. 1 also shows other definitions of subsets of the product value chain 156. The product value chain 156 collects the carbon footprint of all aspects of a product, starting with purchased goods and services 102, capital goods 104, fuel and energy 106, transportation and distribution 108, operational waste 110, business travel 112, employee commute 114, and leased assets 116. These parts of the value chain are collectively known as SCOPE3 indirect upstream activities 138.

The SCOPE2 140 incorporates the purchased energy 118 aspect of the product value chain. The facilities energy 120 and company vehicles 122 are collectively called the SCOPE1 Direct 142 in this product value chain 156. The SCOPE3 indirect downstream activities 144 of the product value chain 156 include the transportation and distribution 124, processing 126, use 128, leased assets 130, franchises 132, investments 134, and end of life 136.

The entire product value chain 156 from purchased goods and services 102 to end of life 136 is called cradle-to-grave (official) 146. The product value chain 156 from purchased goods and services 102 to company vehicles 122 is called cradle-to-gate 148. The product value chain 156 from capital goods 104 to company vehicles 122 is called gate-to-gate 150. The product value chain 156 from transportation and distribution 124 to end of life 136 is called gate-to-grave 152. And the entire product value chain 156 from purchased goods and services 102 to end of life 136 and back is called cradle-to-cradle 154.

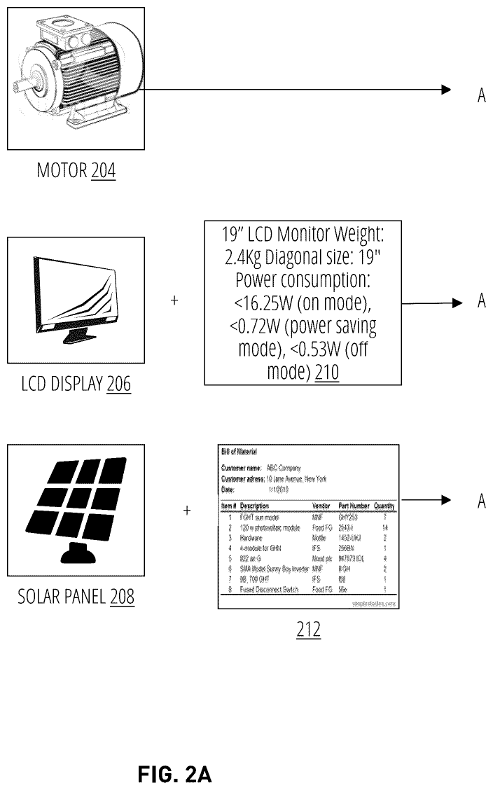

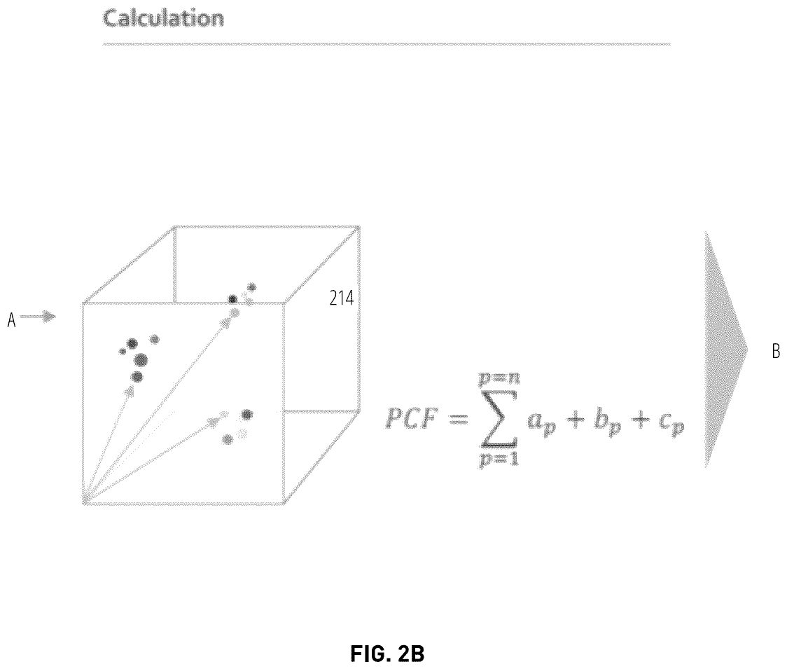

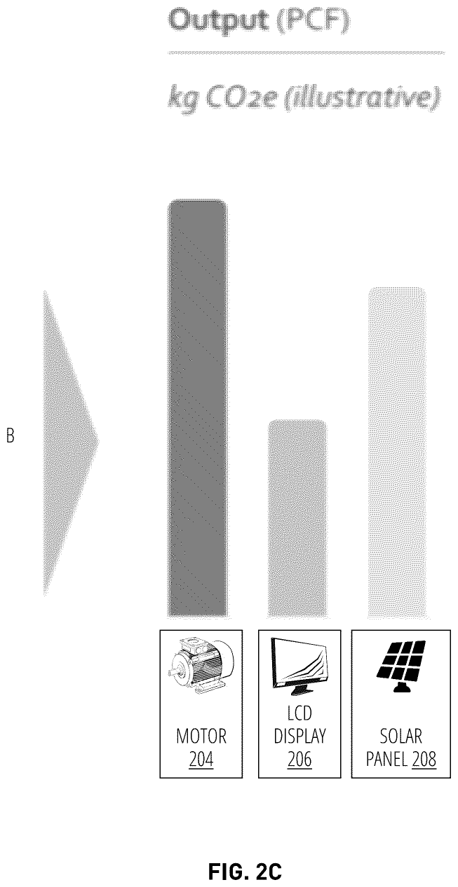

FIG. 2A through FIG. 2C show one embodiment of a high-level overview of the methodology described herein. A model converts the elements of the description of a product (material composition, carbon intensity, etc.) into high-dimensional embeddings. Corresponding carbon footprints are collected from various models/sources. Presented with a new product, a semantic search in the space of embeddings can be used to find the nearest comparable PCFs, which can be used to estimate product carbon footprints. In another embodiment, product descriptions (at whatever level of granularity [ranging from comprehensive to sub-descriptions achieved e.g., via recursive decomposition]) are used e.g., as inputs to various models, such that these descriptions return additional information (such as material composition) that is of relevance to the reconstruction of product carbon footprints (e.g., via the subsequent identification of plausible emissions factors). The methodology accepts whatever level of granularity is easily available, and sums the carbon footprints of the components to derive a product's carbon footprint. In some embodiments, the summing is done through a recursive process.

Both companies and consumers desire to know—and increasingly have a regulatory requirement to understand—the climate impact of the products they buy, manufacture, or sell. This desire for product carbon footprints is quickly outstripping the traditional manual methods used to produce them. It takes weeks to estimate the carbon footprint of a single product; how can one ever hope to handle the 350 million products available in the Amazon marketplace? The only possibility is a fully automated system that can take a simple description of a product and produce an accurate PCF. This problem is decomposed into three major tasks.

First, a fully automated system is built for estimating PCFs in under 1 minute. The standard process for PCF estimation is outlined in ISO 14067:2018 and specifies a series of tasks. It is possible to map this structure to a multi-agent architecture coupled with fact retrieval. Each role (e.g., “Bill-of-materials estimator” or “raw materials carbon footprint estimator”) can be separated into a separate agent and combined by a “manager” agent.

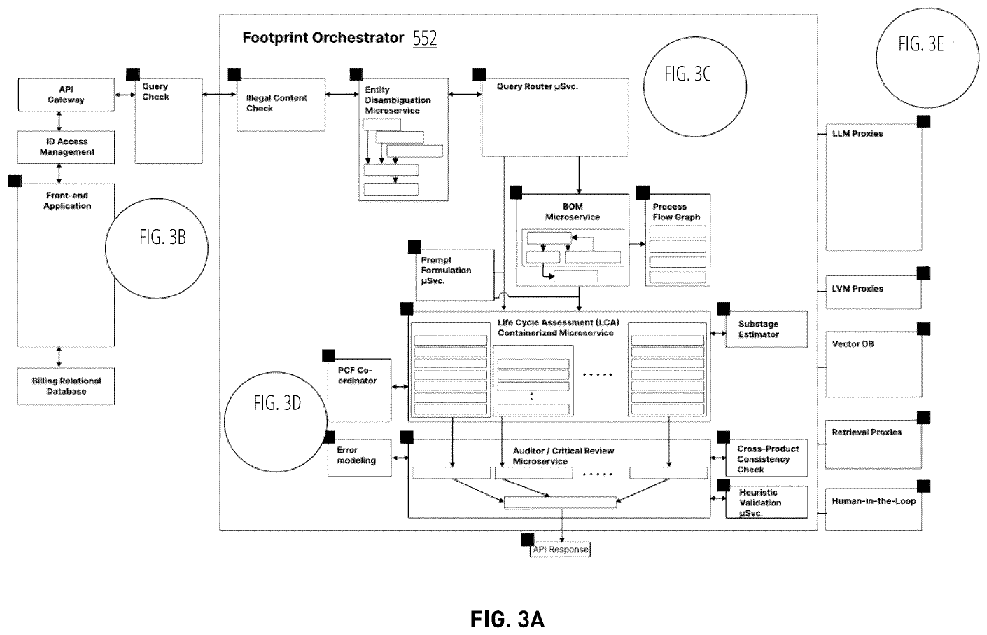

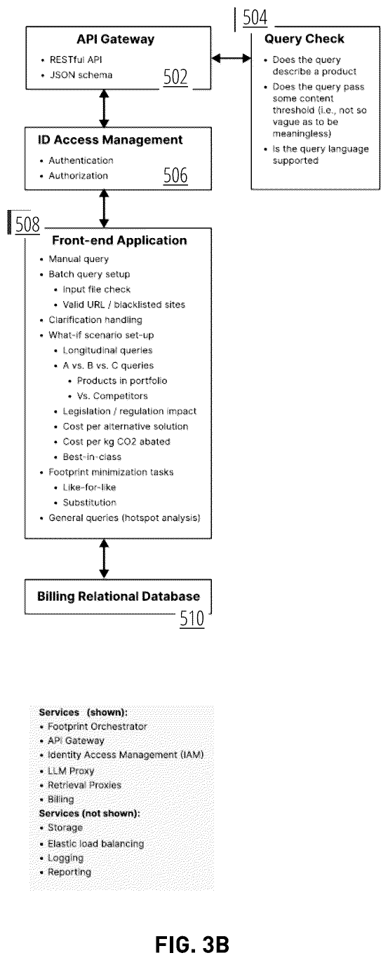

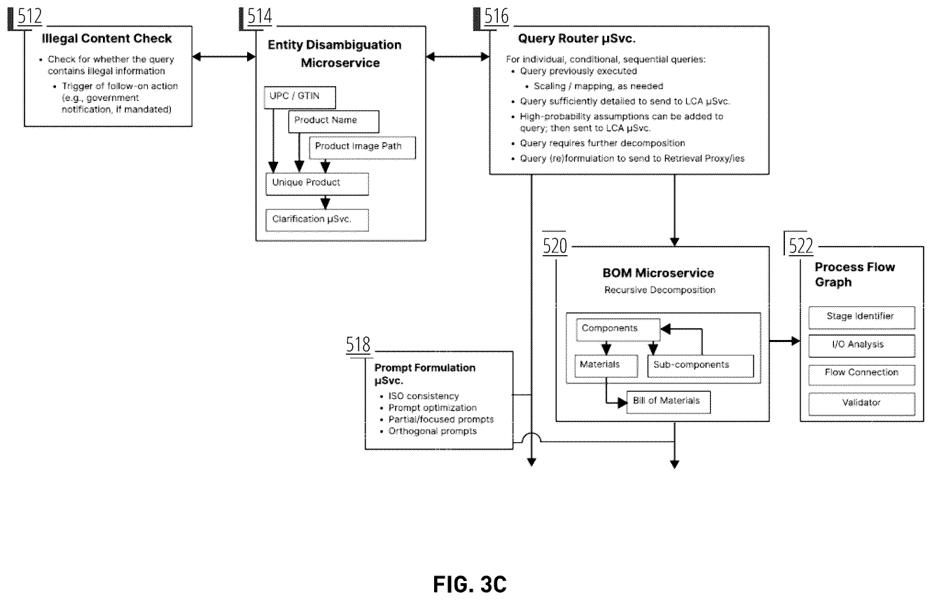

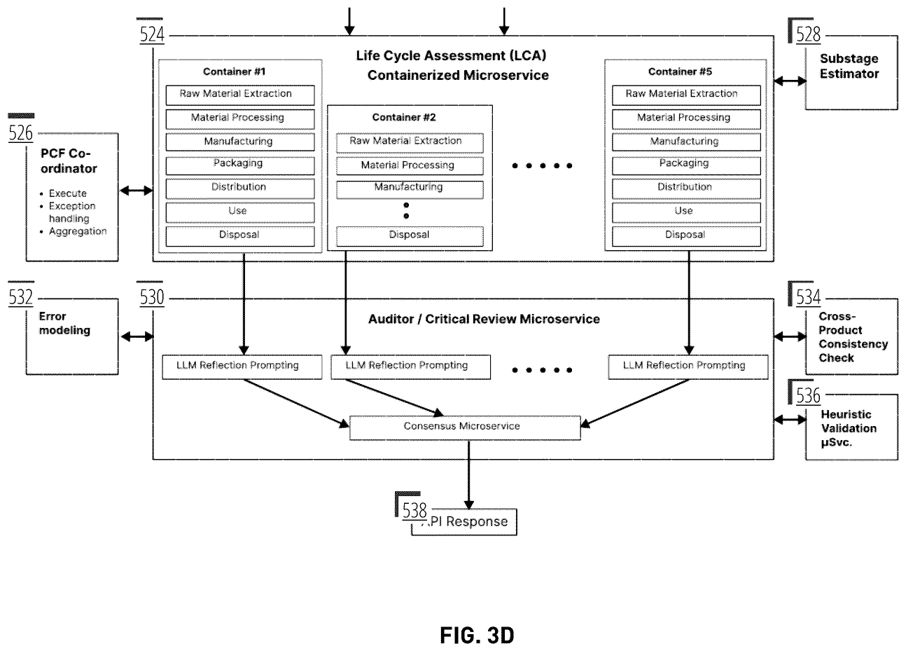

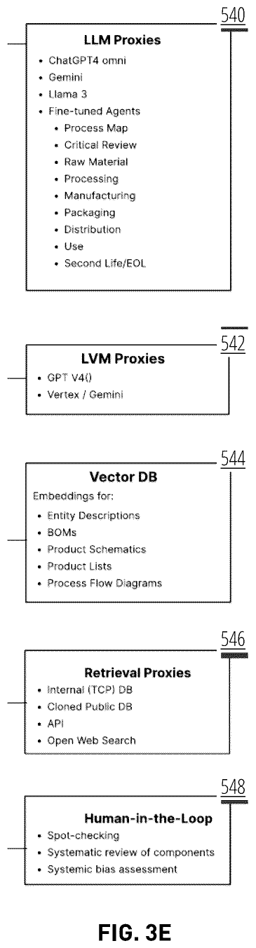

Second, the system is tuned to minimize its error. The median absolute percent error (MAPE) may be used as a performance metric. The methodology evaluates MAPE on a dataset produced in a separate task. The error is reduced by optimizing multiple aspects of the automated system, from the prompts to the fact retrieval to the inter-agent reasoning. FIG. 3A summarizes one implementation of a technical solution.

Third, the variability is measured to determine a quality standard. PCF providers frequently give the impression that they produce a “correct” PCF (e.g., PCF estimates rarely have confidence intervals). However, because there are unknown aspects of any product (particularly in SCOPE3 indirect upstream activities 138 and SCOPE3 indirect downstream activities 144 emissions), PCF estimates vary between experts. By estimating this variance, one can quantitatively determine if an automated system is “as good as an expert”. Building a dataset that captures this variability requires sophisticated augmentation of data from smaller datasets into larger ones.

Looking at FIG. 2A shows the varied input options. In this example, three products for analysis include a motor 204, an LCD display 206, and a solar panel 208, specified by photographs. The motor 204 could be a component unto itself. The LCD display 206 could include text 210 describing the aspects of the LCD display 206: “19″ LCD Monitor Weight: 2.4 Kg Diagonal size: 19″ Power consumption: <16.25 W (on mode), <0.72 W (power saving mode), <0.53 W (off mode)”. For other components, such as a solar panel 208, the component is defined by a bill of materials 212. In FIG. 2A, the output A is sent to FIG. 2B. The product could be specified with identifying information, or sparse data, such as a photograph, a brief text description, a CAD drawing, a sketch, a line drawing, or similar.

FIG. 2B shows one possible calculation of the PCF, taking input A from FIG. 2A. For each individual product (i.e., the motor 204, the LCD display 206 or the solar panel 208), the PCF is calculated as the sum of all discrete components (“p”) (for example, p=1 for a metal housing, p=2 for a stator, p=3 for a ball bearing etc.) of the relevant products across various elements including, but not limited to, materials (denoted “a”), manufacturing (denoted “b”), and logistics (denoted “c”). In some situations, the PCF of a component is recursively calculated through the bill of materials 212. The output B of the calculation in FIG. 2B is sent to FIG. 2C.

FIG. 2C displays the PCF for each of the components: motor 204, LCD display 206, and solar panel 208.

FIG. 3A illustrates one possible system architecture. The diagram overlays cloud services over the model structure, including key inputs, proxies, remote services, and the Footprint Orchestrator. The core of this approach is to use Large Language Models (LLMs) and other mathematical approaches to calculate PCFs starting from broadly available information such as text descriptions, CAD drawings, sketches, line drawings, photographs, etc., of products. In addition, the approach models the certainty of the answers (something that is critical for making informed decisions but is largely absent from current reported values, which are largely point estimates). FIG. 3A is presented in an overview as FIG. 3A, and four sub-figures, FIG. 3B to FIG. 3E, which shows sections of FIG. 3A in more detail.

FIG. 3B show the input processing of the Footprint Orchestrator 552. Predicting a single PCF, a series of PCFs for different products, or variations on PCFs (e.g., time series, or what-if analysis-based), requires some kind of a front-end application 508 to enter query information. This block shows that the Footprint Orchestrator 552 (the entity actually calculating the PCFs) is intended to have a front end that is flexible enough to set up a variety of queries that not only return PCFs but also can go to the next step and put these into a context in which they can be acted on by individuals or companies (“are we getting better over time?”; “how do we compare to competitors?”; “what happens if tariffs are imposed; what does best-in-class look like?”). There is also a need to check that the data entered (file types, URLs) is valid/accepted. In other embodiments, access to the Footprint Orchestrator 552 is through an API Gateway 502.

The query check 504 block attempts to minimize computational time devoted to non-productive queries. Three examples of poor queries: someone inputs e.g., an adjective; someone asks something so vague as to be meaningless; the query is in a language that cannot be currently parsed.

FIG. 3B also shows an ID access management 506 to authenticate and authorize access to the Footprint Orchestrator 552. A billing relational database 510 could also be included to bill customers using the Footprint Orchestrator 552. Additional services may include storage, elastic load balancing, logging, and reporting.

FIG. 3C shows one portion of the Footprint Orchestrator 552. An illegal content check 512 block exists due to government regulations that require disclosure when individuals submit inappropriate content.

An entity disambiguation microservice 514 attempts to reduce a query (as much as possible) to a unique product. To the extent that a query could represent one or a few products, or where a query might have different answers depending on a product characteristic (e.g., manufacturing location or site of usage), the Clarification Microservice (μSvc.) is capable of formulating a request to the Footprint Orchestrator 552 user to see if the user can provide further information (however, absent any information, the inability to precisely define a product would not prevent the Footprint Orchestrator 552 from operating but rather lead to a result that is appropriate ranged or commented to reflect necessary ambiguity due to the query).

The query router microservice 516 block takes product information from the entity disambiguation microservice 514 and assesses how to most efficiently return the requested PCF(s). For example, if a PCF has entirely or mostly been calculated previously, the query router microservice 516 triggers the value to be retrieved from, for example, retrieval proxies 546. The query router microservice 516 also is capable of distinguishing between information that is so detailed that it can immediately be acted on by the life cycle assessment containerized microservice 524 (or where estimating one or two missing pieces of information is sufficient to trigger calling the life cycle assessment containerized microservice 524), versus information that requires further pre-processing (i.e., decomposition into a bill of materials [BOM]), thereby requiring invoking the BOM microservice 520. This microservice also has the ability to take information from the entity disambiguation microservice 514 and create a query that can be executed by a retrieval proxies 546, for example, a web-based search engine. The resulting information can be used to cross-check the values independently calculated by the Footprint Orchestrator 552.

The prompt formulation microservice 518 takes product information required to calculate a PCF and puts it into a prompt e.g., to be used in the context of a generative artificial intelligence model such as large language model (LLM) or large vision model (LVM). Structuring the prompt in a way that generates meaningful output data is essential (that is, an output of “22 kg CO₂e” is not that valuable—what is needed are output data that provide information about product material composition estimates, material weights, carbon intensities, energy use, manufacturing yields, logistics, packaging, etc.). It is also known that prompts can be optimized to yield more accurate results. In some cases, the query router microservice 516 might determine that part of a PCF is already known, in which case a partial query is warranted. To build confidence in answers, one can also approach queries from different “orthogonal” perspectives: the estimated power use associated with manufacturing X should be comparable by asking for the estimated power use for the machine that manufactures X per unit time, divided by the estimated throughput per unit time. Note that this microservice and others referenced herein can be adapted so that they continuously improve their performance against a reference dataset. In other words, the prompt formulation microservice 518 adjusts and improves its prompts to LLMs (or whatever models are used) so as to minimize errors, maximize the percentage of prompts that generate answers, and minimize the time required, amongst other favorable metrics to be fine-tuned.

The BOM microservice 520 block refers to the decomposition of a product (e.g., a pen) into individual materials, by weight. Other products may be decomposed into individual materials by volume. Other products may be decomposed into individual materials, by component (e.g., resistor, capacitor, integrated circuit, connector, and transistor). This information is used to calculate the carbon footprint associated with individual lifecycle sub-steps (like raw material processing or manufacturing).

The process flow graph 522 block maps out all the stages involved in the life cycle of a product, from raw material extraction to end of life 136 disposal. This graph helps in identifying, analyzing, and quantifying the GHG emissions associated with each stage, and is important for ensuring output adheres to industry standards such as ISO 14040:2006 or is compatible e.g., with 14067:2018.

FIG. 3D shows the second portion of the Footprint Orchestrator 552. The life cycle assessment containerized microservice 524 block represents the part of the Footprint Orchestrator 552 that systematically estimates the GHG emissions associated with various value chain steps. The different containers allow for averaging or determining median values (needed due to the probabilistic vs. deterministic nature of machine-learning models).

The PCF coordinator 526 block controls the execution and exception handling of life cycle assessment containerized microservice 524. Exceptions could include a failure to run in an expected amount of time, or the return of an error message. The block also aggregates valid output data.

The substage estimator 528 block divides greenhouse gas emissions into three primary Scopes (SCOPE1 Direct 142, SCOPE2 140, and SCOPE3 indirect upstream activities 138, SCOPE3 indirect downstream activities 144), with the third stage further broken down into 15 subcategories as defined by the Greenhouse Gas Protocol (see https://ghgprotocol.org). Each substage has its dedicated unit.

The auditor/critical review microservice 530 block reviews the calculation output to ensure that it is accurate and complete, and takes remediation steps as necessary (see also below). Directly applying a general-purpose Large Vision Model to product images for component deconstruction may result in a commercially unacceptable error rate, particularly in distinguishing between similar-looking alloys or plastics. Initial attempts yielded error rates exceeding 50%. Through the implementation of the auditor/critical review microservice 530, which uses a specific heuristic validation microservice 536 to cross-check the initial GenAI output against a database of physical and manufacturing constraints, the error rate was reduced to a reliable level below 5%. This multi-stage verification architecture was found to be useful for achieving the accuracy required for a commercial-grade estimation and represents a departure from single-pass GenAI processing.

Various reporting frameworks (for example, the Pathfinder Framework described by the World Business Council for Sustainable Development (“WBCSD”)) guide participating entities to disclose sub-stage calculations and their sources (whether from primary, secondary, or bridging data). The sub-stage decomposition described here provides a critical starting point for adherence to disclosure requirements and a mechanism to sequentially incorporate primary (or secondary) data, as these become available, into PCF estimates/calculations. In some embodiments, the output of the methodology is formatted for auditing and validation by third-party tools.

Independent (that is, 3rd party) validation of product carbon footprints is possible to ensure that rules and methodologies have been followed consistently, to permit apples-to-apples comparisons between similar products, and/or to provide confidence in the values reported. In order to permit PCF validation, the sub-step calculation results could be available through an API or user interface—for example, the carbon intensity per unit activity, or the units of activity per product could be provided. The methodology described herein—by virtue of its decomposition logic—is able to expose these intermediate calculation steps, and thus permit independent auditing of calculated PCF estimates.

The error modeling 532 block attempts to estimate the errors associated with each value returned from the model (or with steps in the calculation process if errors are high for all calculations of one or more steps). This information is returned to the user via an API call, and to the model operator to trigger steps to reduce the model output errors.

The cross-product consistency check 534 block compares data from a calculation (such as the carbon intensity of steel) to prior estimates (stored in vector database 544 and/or retrieval proxies 546) with the goal of flagging values that are not within the scope of what is expected. A “better” estimate may be substituted for a “worse” estimate. The occurrence of an out-of-the-ordinary data value would trigger a report to the model operator.

In some embodiments, cross-product consistency checks are performed either automatically or by presenting a user with a list of inconsistencies. The calculation of PCFs via the application of a decomposition logic, followed by the sum of sub-stage contributions for many different products with similar characteristics (such as similar material composition or similar manufacturing processes), enables the comparison of values across different products (especially those that should be similar in nature). For example, a set of products all using steel produced from a common factory should have, per unit quantity, approximately the same amount of carbon dioxide equivalent emissions. Exceptions can be identified and either accounted for (for example, due to a very high scrap rate or some other extenuating circumstance) or considered in further detail to confirm that a low-quality or incorrect estimate has not occurred. If such an exception is identified, the root cause can be determined and countermeasures are taken so as to improve the accuracy of PCFs and reduce the future occurrence of poor estimates.

In some embodiments, the sub-step estimates can be replaced by known values either from an API or through a user interface. Once PCFs have been calculated, it is possible to refine these estimates by focusing on those areas making significant contributions by virtue of the carbon intensity per unit activity or the units of activity per product and gathering primary data for these steps. The decomposition logic described herein permits activity data and emissions factors for specific sub-step calculations to be adjusted by the addition of secondary (e.g., industry average) or primary (directly measured) data. In the limit, all sub-step calculations could be refined (for example, in decreasing order of their contribution towards the overall PCF) by substituting known activity and emission factor data for estimates.

The heuristic validation microservice 536 block aims to further check PCFs via referencing known facts or physical constants that impose constraints on a PCF. For example, if an orthogonal query (see prompt formulation microservice 518) inquires what the maximum temperature any raw material is heated to during the manufacture of a particular product, the returned estimate in some sense imposes a constraint on the resulting PCF. As an example, a ceramic coffee mug would implicitly have a high footprint due to a requirement to fire clay in a kiln, absent evidence that the kiln was powered by low-carbon energy.

The Generative Artificial Intelligence/LLM Proxies 540 block refers to the set of Generative Artificial Intelligence models, such as large language models (LLMs), that the Footprint Orchestrator 552 might call e.g., to execute the lifecycle assessment process shown in the life cycle assessment containerized microservice 524. The Footprint Orchestrator 552 might initially use commercially available LLMs (e.g., ChatGPT, Vertex/Gemini) and may later use custom LLMs if these prove to be faster, more accurate, less expensive, or have some other competitive advantage.

The LVM proxies 542 block represents Large Vision Models (LVMs), and these are commercial or private solutions to take images and convert them into textual descriptions as the basis e.g., defining a query as referring to a specific product (see entity disambiguation microservice 514).

The vector database 544 block contains product-description information that is necessary to execute a query. This may include embeddings for entity descriptors, bills of materials, product schematics, product lists, process flow diagrams, etc.

The retrieval proxies 546 block represents information that is helpful to calculate PCFs (or, in the case of the “Internal (TCP) DB” is a database containing already run queries) as well as other pertinent information such as the queries used, the versions of software or databases accessed, and any other information that clarifies how a particular product carbon footprint was calculated). As one example, if data (or preferred estimates) exist e.g., activity data, emission factors, and global warming potentials, these could be returned to the Footprint Orchestrator 552 and used in place of other values. This is relevant to cases where companies wish to report the Primary Data Share (PDS) for a PCF, as recommended in the Pathfinder Framework published by WBCSD.

The human-in-the-loop 548 block indicates the ability to take specific predictions or other intermediate or final work products from the Footprint Orchestrator 552 and pass these data to individuals who are capable of further evaluating them. As an example, one might predict that a certain product is manufactured using a certain process. This prediction could be passed to a contractor with knowledge of manufacturing processes, who could evaluate the plausibility of the prediction and further adjust or annotate the prediction, as needed, with the ultimate goal of improving the accuracy of PCF calculations.

The API response 538 block indicates that PCFs and PCF-related data are exposed by the Footprint Orchestrator 552 to authorized entities.

The above methodology uses continuous learning such that the PCF model can self-optimize by e.g., fine-tuning prompts, doing bill of material (BOM) decomposition to different levels of resolution, and changing the LLM/other model selected to run a prompt.

The architecture described herein is designed to drive self-optimization through continuous learning. For example, the query check 504, the entity disambiguation microservice 514, the BOM microservice 520, the prompt formulation microservice 518, the life cycle assessment containerized microservice 524, the auditor/critical review microservice 530, and the LLM Proxies 540 can all be implemented in a way to self-optimize. By optimization, we mean one or more attributes such as cost, error, re-work, and/or the number of redundant calculations are minimized, while desirable attributes such as speed and calculation resolution are maximized. By continuous learning, we mean that rapid initial answers are iteratively refined to second, third, and nth refinements in an automatic fashion guided by appropriate optimization functions.

As shown in the front-end application 508, the front end can be set up to accept input that can trigger multiple PCF analyses, for example via specific instructions to query router microservice 516 and prompt formulation microservice 518 (including, but not limited to triggering de novo analyses and returning results from prior analyses).

Time Evolution. In one embodiment, a series of PCFs might be returned that show how these footprints have evolved or may evolve in the future if planned actions are taken or are not implemented. The planned actions may include activities that comprise those that change the type, geographic source and percent recycled content, the manufacturing processes (such as: the number and type of process steps; the substitution of lower-GHG-emitting equipment for higher-GHG-emitting equipment including through energy-efficiency retrofits; the more efficient (and therefore lower-GHG-emitting) organization of equipment and people), the logistics mode (where we consider an electrified mode of transport to be distinct from one operating using fossil fuels), the logistics routing, and other overhead activities.

Product Evolution. In another embodiment, a series of PCFs could be calculated based on different real or hypothetical conditions including, but not limited to, product material use, product material composition (i.e., the quantities of specific materials used), manufacturing processes, operating conditions and/or what happens at a products' end-of-life. These various PCFs could be compared along criteria to optimize decarbonization decisions, accounting for tradeoffs including cost, speed of implementation, feasibility of implementation, and manufacturing supply chain robustness. Criteria could include cost per unit GHG emissions reduced, cost, and GHG emission reduction. The criteria could be assessed across individual lifecycle steps or in aggregate.

Product Comparisons. In another embodiment, PCFs might be calculated, where the PCFs may represent products that are substantially similar (for example, two passenger vehicles), or where the products achieve a desired outcome but the products are substitutes for each other (for example, a small city car versus an electric cargo bike).

Portfolio Comparisons. The high speed and computational efficiency enable analyses at a portfolio level. In some embodiments, the processing units are configured to calculate a respective carbon footprint metric (CFM) for each product within a plurality of products defining a product portfolio. A CFM can refer to the total product carbon footprint (PCF) for a product, or it can refer to a carbon footprint sub-component. Such sub-components may correspond to a specific stage of the product lifecycle, such as, but not limited to, the raw materials acquisition, manufacturing processes, transportation, product use, or end-of-life disposal. A sub-component may also correspond to a specific input, such as the carbon footprint attributable to a particular material or energy source. The calculation for each product generates a set of calculated CFMs for the portfolio. The processing units may be configured to generate a portfolio-level aggregate carbon metric based at least in part on the set of calculated CFMs. The aggregated carbon metric may be generated by aggregating the set of CFMs. Aggregation methods may include, but are not limited to, calculating a sum, an arithmetic mean, or a weighted average of the CFMs in the set. This aggregated carbon metric may serve as a quantitative indicator of the portfolio's overall carbon intensity. The system can thereby facilitate a comparison between portfolios. For instance, the processing units may be configured to compare a first aggregated carbon metric of a first portfolio (e.g., a company's current product line) with a second aggregated carbon metric of a second portfolio (e.g., a competitor's product line or a historical version of the first portfolio) to assess relative performance or track progress over time. The result of this comparison may be stored or displayed to a user. Furthermore, in some embodiments, the processing units are configured to determine an estimated portfolio-level cost of decarbonization. This may be accomplished by receiving decarbonization cost data for individual products, calculating a potential cost to achieve a target CFM reduction for each product, and aggregating these individual costs to determine an overall cost for the portfolio.

Partition-Based Portfolio Analysis. In additional embodiments, the processing units may be further configured to divide the set of calculated CFMs according to one or more customer-defined criteria, such as selecting the top Xth percentile of products by carbon intensity (e.g., the worst polluting 10%) or any other threshold or grouping of interest. The division may be a partition, or overlapping subsets, or a hierarchy of increasingly granular subsets. For each resulting subset, the system can analyze CFMs across multiple products to identify targeted opportunities for supply chain environmental efficiency—such as recommending substitution of high-emitting suppliers or materials with alternatives exhibiting lower CFMs—and to assess supply chain robustness by detecting common materials, manufacturing processes, or logistical pathways that present bottlenecks or single-points-of-failure. The processing units may output these analytical findings in a variety of formats, including machine-readable data structures (e.g., JSON or XML), visualization-ready datasets for graphs or dashboards, or formatted human-readable reports. Such outputs may be generated for a single portfolio to provide descriptive insights or employed to compare analytic results between two or more portfolios (for example, current vs. historical product lines or competitor offerings) to support benchmarking, trend tracking, and strategic decision-making.

Cost Analyses. Businesses may want to produce derivative products that have reduced PCFs compared to original products. They may also wish to optimize the reduction in one or more PCFs subject to a cost or budget limitation. They may also wish to minimize the cost a company might have to pay due to an existing or future price of carbon (that is, a cost is added to that of a product due to its carbon intensity). The front end described herein may be set up such that the cost of one or more products might be minimized through the reduction in sub-component PCF values. Such an activity would be warranted if there is a cost associated with the embodied carbon within a product, as anticipated by for example so-called cross-border adjustment mechanisms (CBAMs). These or other similar schemes are designed to impose a cost on products based on the so-called embodied carbon, in the case of CBAMs, the carbon that is intrinsic to products prior to their importation into a country or territory imposing cross-border fees based on carbon intensities.

Supply Chain. The results from historical, conditional, or predictive PCF analyses may be used to propose how to meet specific goals related to product supply chains, including but not limited to, cost reduction or optimization, carbon footprint reduction or optimization, product availability, and supply chain robustness (for example, how to have products available in a way that maximizes revenue through sales, while minimizing costs due to a lack of product availability and the need to restock through more expensive actions, including but not limited to more expensive—and potentially more carbon intensive—air-freighting of products to distribution and/or sale points).

There is an enormous demand for product carbon footprint (PCF) of commercial products. This demand is driven by a combination of regulatory requirements and consumer pressure. For example, the EU's Carbon Border Adjustment and the UK's similar efforts will enter their final stage, requiring PCFs for foreign products in 2026. EU regulations require PCFs across the battery market by 2028. Oliver Schmid of Hyundai warned that “PCFs are the next big thing” for the automotive industry. California's SB 253, the Climate Corporate Data Accountability Act (CCDAA), which went into effect in 2025, implicitly requires PCFs in order to estimate Phase 3 emissions. The retail giant Amazon announced in their 2022 sustainability report that it would be requiring all suppliers to report emissions by 2024; this requirement also leads to heightened demand for PCFs. To underscore the scale of the problem, consider Amazon's marketplace. Including third-party sellers, their marketplace handles in excess of 350 million products. Any PCF process requiring even a single day of data gathering would necessitate approximately a million person-years of effort. More broadly, 90% of companies lack emissions visibility into their supply chains. This unmet need can only be addressed by a fully automated PCF estimator that can provide accuracy to a quality standard in under a minute.

The Footprint Orchestrator 552 is designed to estimate PCFs by implementing ISO 14067:2018. The system employs several additional steps to account for the vagaries of automation.

The system is composed of a set of predictive agents, each of which attempts to estimate a different facet of a product's life cycle. A special agent coordinates the work of the other agents. Each agent is built by a set of general artificial intelligence (e.g., LLM) prompts. The same prompt is run multiple times in parallel to avoid anomalous results. Secondary prompting applies self-reflection to improve accuracy.

The accuracy of the agents is improved by access to publicly available databases of carbon intensities. For example, if a Bill of Materials reveals that a product uses 3 kg of aluminum, the agent can look up the relevant carbon intensity (kg CO2e per kg of material). In one embodiment, one can use retrieval augmented generation (a RAG), built through LangChain, for automating database 702 access.

The entity disambiguation microservice 514 tackles the initial challenge of identifying the exact product intended from a potentially vague description. Its goal is to accurately determine the intended product or flag the description as too ambiguous. The design targets a failure rate of less than 1%, ensuring high reliability in product identification.

The BOM microservice 520 is responsible for estimating the complete list of materials involved in the product's lifecycle.

The life cycle assessment containerized microservice 524 analyses the entire product life cycle, including raw material extraction, processing, manufacturing, packaging, distribution, usage, and disposal.

The substage estimator 528 divides greenhouse gas emissions into three primary stages (see above for Scope 1, 2, and 3 definitions), with the third stage further broken down into fifteen subcategories. Each substage has its dedicated unit.

The PCF coordinator 526 amalgamates all the data gathered and processed by the other units into a cohesive PCF estimate.

The auditor/critical review microservice 530 acts as the quality control layer, reviewing the entire analysis for accuracy and completeness. Should the first analysis fail to meet standards, it triggers a re-evaluation. If the second attempt also fails, the system records a prediction failure, with a targeted failure rate below 1%.

The error modeling 532 splits a silver dataset (consisting of the PCF error distributions for ca. ten thousand products for which the 1st and 3rd quartile errors have been estimated so as to compute the quartile coefficient of variation across the entire silver dataset) into training (40%), testing (40%), and validation (20%). Error evaluation consists of:
Selecting a split of the data (i.e., train/test/eval)
Applying the Footprint Orchestrator 552 to the split to produce PCFs
Computing the MAPE of the Footprint Orchestrator 552
Computing the quartile coefficient of variation (qCOV) of the split.

The approach described herein is designed such that the validation dataset error becomes as good as (or better than) a quality standard (i.e., if MAPEqCOV).

In those cases where the database 702 used for the RAG is insufficient for the queries involved, one can add additional databases as appropriate.

The performance of an agent is governed by its prompt. The prompt formulation microservice 518 optimizes the prompts through automatic prompt optimization tools to further improve performance.

In one embodiment, each unit of the system deploys multiple agents operating in parallel. This can be improved in various ways to exploit the joint information between the agents, for example, by implementing a Language Agent Tree Search (LATS) architecture or Tree-of-Thought (ToT) reasoning to enhance problem-solving capabilities. Also, by introducing a critic agent, it is possible to make pairwise comparisons between other agents, which helps in ranking and selecting the best responses over the traditional consensus method.

The approach described here augments the self-reflection capabilities of each agent by adopting more sophisticated techniques (e.g., Reflexion). This improvement enhances each agent's ability to assess and correct its outputs, leading to more accurate estimations.

Depending on the specific requirements of each agent, one may deploy different general artificial intelligence models and/or different LLMs to optimize performance. For instance, while an LLM offered by Facebook might suffice for standard estimations, more critical functions such as those performed by the PCF Coordinator and the Auditor may benefit from the advanced capabilities provided by products from OpenAI, Google, Anthropic, or DeepSeek

The LCA Analyzer and Sub-Scope Estimators both produce PCFs internal to the Footprint Orchestrator 552. In one embodiment, the system is restricted to utilize either one or the other in specific contexts, where such limitations enhance overall accuracy.

These technical innovations may have broader societal impacts.

By enabling companies to rapidly assess and manage their carbon footprints, the innovation empowers businesses to lead in sustainability practices globally. Companies can leverage this technology to enhance their environmental credentials, appeal to a growing market of eco-conscious consumers, and comply with increasingly strict regulations on carbon emissions both domestically and internationally. This capability can serve as a crucial competitive advantage in global markets.

By making carbon footprint data easily accessible and understandable, the technology innovation can play a significant role in educating the public about the impacts of their consumption choices on the environment. This, in turn, can lead to more informed decisions and greater public engagement with sustainability issues, and vastly improve public scientific literacy and engagement with science and technology. The approach described herein essentially democratizes PCF information.

Climate change is an existential crisis for humanity and directly impacts public health. By facilitating a detailed understanding and reduction of carbon footprints, the technological innovations described herein help reduce pollution, mitigate the effects of climate change, and contribute to cleaner air and water. This reduction in environmental pollutants as a result of more sustainable manufacturing and material practices can decrease the incidence of health conditions like asthma and other respiratory ailments, thus further enhancing public health. Given the ubiquitous nature of climate change, this innovation has the potential to positively benefit global society.

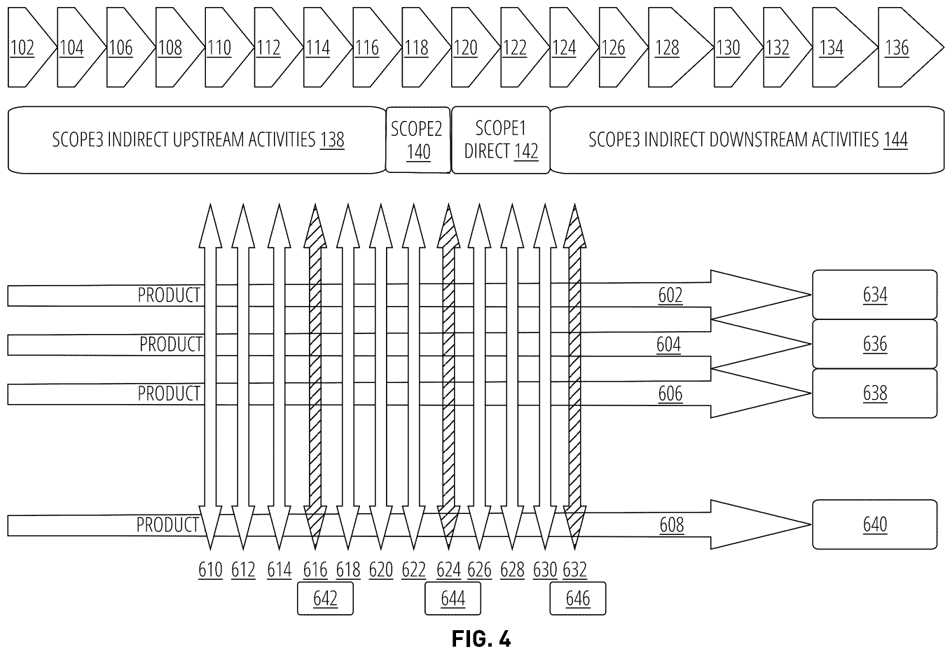

FIG. 4 shows the underlying calculation logic and the types of insights. The top of FIG. 4 shows the steps in the product life cycle described in FIG. 1. For each “product” product 1 602, product 2 604, product 3 606 . . . product n 608, the Footprint Orchestrator 552 calculates the sub-component carbon footprints for subcomponent X carbon footprint 642, subcomponent Y carbon footprint 644, subcomponent Z carbon footprint 646, etc. Each of the subcomponent carbon footprints 642, 644, 646 comprise a quantity X 610, a quantity adjustment 612, an emission factor X 614, and a footprint X 616 that are used as factors in calculating the subcomponent X carbon footprint 642. Once the subcomponent carbon footprints 642, 644, 646 are calculated for each product 602, 604, 606, 608, the PCF for the subcomponents are summed to calculate the product 1 carbon footprint 634, the product 2 carbon footprint 636, the product 3 carbon footprint 638, and the product n carbon footprint 640. The products 602, 604, 606, 608 could be a comparison of PCFs for different products to choose for purchase, or could be a comparison of the PCF for a product at different time frames. In other situations, the products 602, 604, 606, 608 could be using various “what-if” scenarios. In other situations, the subcomponent carbon footprints 642, 644, 646 for each product 602, 604, 606, 608 are compared as part of a so-called hot-spot analysis that identifies major drivers of carbon emissions across one or more products. In other situations, a numeric quantity (for example, units produced or units purchased or units sold) is used to weight the subcomponent carbon footprints 642, 644, 646 for each product 602, 604, 606, 608 to be compared as part of a hot-spot analysis. Such a weighting may be used to evaluate the relative contribution of 634, 636, 638, 640 to portfolio emissions.

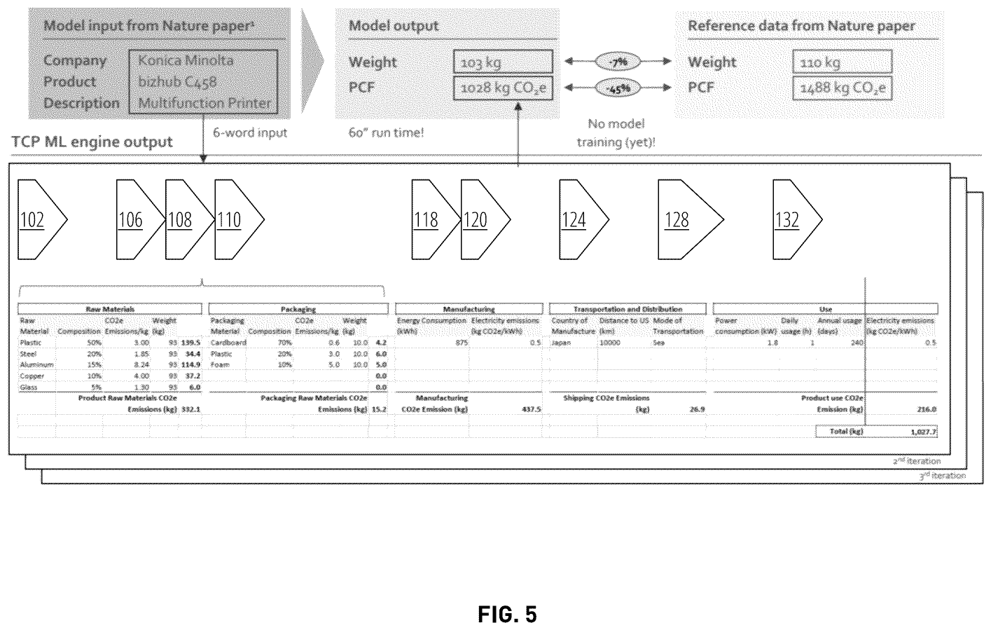

FIG. 5 shows one possible output screen showing a deep-dive product carbon footprint example. This shows the various product life cycle elements 102, 106, 108, 110, 118, 120, 124, 128, 132 that impact this particular report.

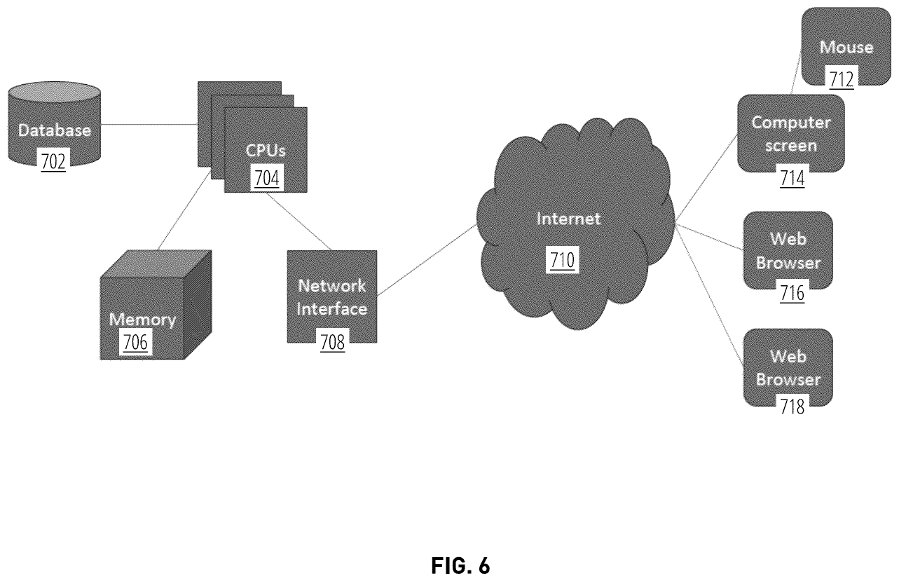

As shown in FIG. 6, one possible embodiment of the hardware components required to implement the software functionality is described. In one embodiment, the PCF and the error estimate are stored in data structures in the database 702. The database 702 could be on any type of data storage device, from a RAID disk array, a hard drive, optical storage, a solid-state drive, tape drives, or other data storage devices. The database 702 is connected to one or more processing units (CPUs 704). The database 702 could be local or remote, accessible through the network interface 708 over a network, such as the internet 710. In some embodiments, the database 702 is distributed across different storage units either locally or remotely. The connection could be optical, electrical, wireless, or a similar type of connection. The CPUs 704 could be microprocessors, ASIC, processing cores, or similar. The CPUs 704 could be connected (electrically, optically, or wirelessly) to a memory 706, an input device, an output device, and a network interface 708. The memory 706 could be random access memory, EEPROM, PROM, NVROM, etc. The memory 706 may include non-transitory machine-readable instructions for the CPUs 704. The network interface 708 could be any interface to a computer network. The network interface 708 could be an optical connection, an electrical connection, or a wireless connection. The network interface 708 could connect to an Ethernet network (IEEE 702.1, 702.3), to a Wi-Fi network (IEEE 702.11), Bluetooth, Broadband through cable modems, mesh networks, cellular networks, or other network protocols. The CPUs 704 may also connect directly or indirectly to a computer screen 714. The computer screen 714 may be associated with a mouse 712, touch screen, touchpad, keyboard, haptic device, or other input device. In some embodiments, the CPUs 704 connect to a web browser 716, 718. The input device could be a keyboard, a touchscreen, a computer storage device, a database, a barcode scanner, a microphone, an RFID tag reader, a QR code reader, a camera, a network interface 708, an application program interface, an email server, a web browser, etc. The output device could be a computer screen 714, a web browser, a printer, a computer storage device, a network interface 708, an application program interface, a speaker, a television, an email server, etc.

In one embodiment, the network interface 708 could connect to the internet 710, and through the internet 710 to web browsers 716, 718 on a computer screen 714. Web browsers 716, 718 and computer screens 714 could have various input devices, such as a computer mice 712, touch screens, touch pads, keyboards, haptic devices, or similar. Web browsers 716, 718 could have screens, monitors, projection devices, or similar display technology.

In some embodiments, the product name and/or description could be provided by an application program interface (API) or through a remote procedure call (RPC), and the resulting carbon footprint could be returned through the API or RPC.

The present inventions have been described in terms of specific embodiments incorporating details to facilitate the understanding of the principles of construction and operation of the inventions. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the inventions as defined by the claims. All dimensions are given as examples and may be changed without detracting from the inventions herein.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present inventions include such changes and modifications.

1. An apparatus for calculating a carbon footprint of a product comprising:
one or more processing units;
memory electrically connected to the one or more processing units;
an input device, connected to the one or more processing units;
an output device connected to the one or more processing units; and
wherein the memory includes non-transitory machine-readable instructions for the one or more processing units to:
receive, from the input device, identifying information of the product, wherein the identifying information lacks a complete, pre-defined bill of materials;
disambiguate the identifying information to derive a unique product identifier;
recursively search for components of the product;
determine the carbon footprint of each component;
if instructed, substitute a known carbon footprint for each component;
sum the carbon footprint of each component;
add the carbon footprint to an additional product carbon footprint component of manufacturing of each component;
add the carbon footprint to shipping and transportation for each component;
model an error estimate for the carbon footprint;
store the carbon footprint and the error estimate for each component in a database;
search the database for a previously calculated carbon footprint and a previous error estimate of each component; and
return the carbon footprint and the error estimate for the previously calculated carbon footprint or the carbon footprint, depending on which error estimate is lower; and
send the carbon footprint and the error estimate on the output device.

2. The apparatus of claim 1, the input device is a network interface connected to a network.

3. The apparatus of claim 1, the output device is a network interface connected to a network.

4. The apparatus of claim 1, where the input device is a keyboard.

5. The apparatus of claim 1, wherein the additional product carbon footprint component is overhead.

6. The apparatus of claim 5, wherein the overhead includes capital goods, fuel and energy, and operational waste.

7. The apparatus of claim 1, where the shipping and transportation includes business travel and employee commute.

8. The apparatus of claim 1, wherein the carbon footprint of each component is determined using a generative artificial intelligence model.

9. The apparatus of claim 8, where the generative artificial intelligence model is a large language model.

10. The apparatus of claim 9, wherein the steps to calculate the carbon footprint self-optimize.

11. The apparatus of claim 10, where the self-optimization optimizes prompts to the generative artificial intelligence model.

12. The apparatus of claim 10, where the self-optimization changes the generative artificial intelligence model used.

13. The apparatus of claim 1, wherein the one or more processing units format the carbon footprint and the error estimate to support 3rd party validation.

14. The apparatus of claim 1, wherein the one or more processing units format the carbon footprint and the error estimate to support 3rd party audits.

15. The apparatus of claim 1, where the identifying information is a photograph.

16. A method for calculating a carbon footprint of a product comprising:
receiving, from an input device, information identifying of the product, where the input device is connected to one or more processing units;
disambiguate, by the one or more processing units, the information identifying of the product to derive a unique product identifier;
recursively executing steps of:
searching for components of the product;
determining the carbon footprint of each component;
if instructed, substituting a known carbon footprint for each component;
summing the carbon footprint of each component;
adding the carbon footprint of an overhead of manufacturing of each component;
adding the carbon footprint of shipping and transportation for each component;
modeling an error estimate for the carbon footprint;
storing the carbon footprint and the error estimate for each component in a database;
searching the database for a previously calculated carbon footprint and a previous error estimate of each component; and
returning the carbon footprint and the error estimate for the previously calculated carbon footprint or the carbon footprint, depending on which error estimate is lower; and
sending the carbon footprint and the error estimate to an output device connected to the one or more processing units.

17. The method of claim 16, where the input device is a network interface connected to a network.

18. The method of claim 16, where the output device is a network interface connected to a network.

19. The method of claim 16, where the output device is a computer screen.

20. The method of claim 16, where the shipping and transportation includes company vehicles and distribution.

21. The method of claim 16, wherein the carbon footprint of each component is determined using a generative artificial intelligence model.

22. The method of claim 21, where the generative artificial intelligence model is a large language model.

23. The method of claim 22 further comprising self-optimizing the steps to calculate the carbon footprint.

24. The method of claim 23, where the self-optimizing optimizes prompts to the generative artificial intelligence model.

25. The method of claim 23, where the self-optimizing changes the generative artificial intelligence model used.

26. The method of claim 16 further comprising formatting the carbon footprint and the error estimate to support 3rd party validation.

27. The method of claim 16 further comprising formatting the carbon footprint and the error estimate to support 3rd party audits.

28. The method of claim 16, where the information identifying of the product is a brief text description.

29. The method of claim 16, where the information identifying of the product is received through a network interface.

30. A method for calculating a carbon footprint of a portfolio of products comprising:
receiving, from a computer screen, information identifying of the portfolio of products;
for each product in the portfolio of products:
disambiguate, by one or more processing units, the information identifying of the portfolio of products for each product to derive a unique product identifier;
recursively executing steps of:
searching for components of each product;
determining the carbon footprint of each component;
if instructed, substituting a known carbon footprint for each component;
summing the carbon footprint of each component;
adding the carbon footprint of an overhead of manufacturing of each component;
adding the carbon footprint of shipping and transportation for each component;
modeling an error estimate for the carbon footprint;
storing the carbon footprint and the error estimate for each component in a database;
searching the database for a previously calculated carbon footprint and a previous error estimate of each component; and
returning the carbon footprint and the error estimate for the previously calculated carbon footprint or the carbon footprint, depending on which error estimate is lower;
summing the carbon footprint for each product into an aggregate carbon footprint; and
displaying the aggregate carbon footprint on the computer screen.
